(19) United States
(12) Patent Application Publication
(10) Pub. No.: US 2012/0005958 A1
(43) Pub. Date: Jan. 12, 2012

(54) Hydroponic Plant Growing System

(76) Inventor: Robert B. Laitsch, Cortez, CO (US)

(21) Appl. No.: 13/177,380

(22) Filed: Jul. 6, 2011

Related U.S. Application Data
(60) Provisional application No. 61/363,368, filed on Jul. 12, 2010.

(51) Int. Cl. A01G 31/02; A01G 31/00

(52) U.S. Cl. 47/62 R; 47/59 R

(57) ABSTRACT

A hydroponic system is provided that employs a bag formed of generally flat plastic tubing. Each bag includes a plurality of growing spaces that are defined by barriers that interconnect a first surface of the bag to a second surface of the bag. The barriers are non-continuous such that at least one channel is provided between adjacent growing spaces.

This application claims the benefit of U.S. Provisional Patent Application Ser. No. 61/363,368, filed Jul. 12, 2010, the entire disclosure of which is incorporated by reference herein.

### FIELD OF THE INVENTION

Embodiments of the present invention are generally related to bags used in hydroponic growing systems.

### BACKGROUND OF THE INVENTION

Hydroponics is a method of growing plants using mineral nutrient solutions in water in the absence of soil. Some advantages of using hydroponics for food processing are that no soil is needed; the water and nutrients can be reused, thereby lowering water costs; control of nutrient levels is enhanced; no pollution is released into the environment; stable and high yields may be achieved; and pests, diseases and soil borne pathogens are easier to address due to the mobility of the hydroponic bags. Some hydroponic systems only use a nutrient solution, while others support the plants with inert mediums such as perlite, gravel, mineral wool, coir fiber, or coconut husks. Some hydroponics systems provide a continuous flow of nutrient solution to the roots of the plants. In these systems the flow, temperature and nutrient concentrations of the nutrient solution can be selectively adjusted. Further, many hydroponic systems are comprised of vertically-oriented bags or tubes having a plurality of openings that receive plants.

One drawback of the hydroponic systems of the prior art is that they employ a bag with a shared growing medium wherein roots intermingle and clog nutrient flow channels. Further, some systems of the prior art employ seals around plant crowns to prevent fluid loss. These seals result in high water concentration at the plant crown which often results in crown rot and plant death. As the plants share a continuous soil column, removal of a dead plant without disturbing all adjacent plants is difficult, if not impossible. Further, systems that employ vertical columns with side or bottom openings that receive transplanted plants are difficult, if not impossible, to sow with seeds.

Thus it is a long felt need to provide a hydroponic plant growing system wherein individual plants are isolated from each other such that each plant receives a predetermined amount of nutrient. The following disclosure describes a hydroponic growing bag having a number of distinct growing spaces that are defined by barriers or other obstructions that isolate adjacent growing spaces from each other.

### SUMMARY OF THE INVENTION

It is one aspect of the present invention to provide a hydroponic plant growing system that employs bags constructed of plastic tubing that possesses a plurality of separate growing spaces. In one embodiment, the bags are comprised of flat plastic tubing having a front surface and a rear surface that are interconnected on lateral edges. The front and rear surfaces touch each other when the bag is empty. Each growing space is separated by a barrier, preferably formed of an ultrasonic weld that interconnects the front surface of the tubing to the back surface of the tubing. Heat or pressure welds may also be used to create the barriers. Access to each individual growing space is provided by an opening in an upper portion of the growing space through at least one of the front surface or the back surface. In one embodiment both sides of the tubing possess openings. Thus, when the bag is oriented such that the openings face north and south, the plants may be integrated on both sides of the bag which provides sunlight exposure from all angles. In addition, the planar sides of the flat tube reflect light to adjoining tubes.

It is another aspect of the present invention to provide a hydroponic plant growing system with bags that efficiently transfer nutrient solution therethrough. More specifically, the barriers described above of some embodiments of the present invention are non-continuous across the width of the bag which defines a channel within the bag that allows fluid to travel from an upper growing space to an adjacent lower growing space. The channel is defined by the front surface of the bag, the rear surface of the bag and the lateral edge of the bag. As the fluid level, and therefore water pressure associated with a particular growing space, decreases, the area of the space between adjacent spot welds will decrease weld which slows the rate of flow out of the growing space. Other embodiments of the present invention include a series of spot welds spanning at least a portion of the width of the tubing that helps retain growing media within the growing space. The spacing of the spot welds also controls the rate of nutrient solution outflow from each growing space.

It is another aspect of the present invention to provide a hydroponic plant growing system that is supportable by a pipe, a wire, a rod, etc. More specifically, embodiments of the present invention include a series of hooks or other mechanisms that engage a horizontally oriented support to orient the bags vertically. Further, a fold or loop integrated into a top edge of the bag may be used for receiving the pipe, rod, etc. A liquid source is provided that feeds water into an uppermost opening of the hydroponic plant growing system.

It is another aspect of the present invention to provide a hydroponic bag, comprising: a first surface and a second surface interconnected at a first edge and a second edge to define a flat tube; a plurality of growing spaces located between said first surface and said second surface, each of said growing spaces associated with an opening formed in at least one of said first surface; and a plurality of barriers provided between said first surface and said second surface that separate adjacent growing spaces, at least one of said plurality of barriers spanning only a portion of the distance between said first edge and said second edge such that at least one channel is provided that allows fluid communication between adjacent growing spaces.

It is still yet another aspect of the present invention to provide a hydroponics growing system comprised of a tube with a plurality of openings that is hung vertically, said tube receiving growing media positioned in discrete growing spaces that receives a plant via said openings, said tube having at least one fluid inlet that is in fluid communication with said growing spaces, an improvement comprising: non-continuous barriers located between adjacent growing spaces.

It is also an aspect of the present invention to provide a method of growing plants comprising: providing a hydroponic bag that is comprising a series of fluidically associated discrete growing areas, each growing area being accessible by an opening in said bag; proving non-continuous barriers between said growing spaces; adding growing medium to said discrete growing spaces; introducing a plant into said growing space; introducing a fluid to said hydroponic bag; and percolating said fluid from one growing space to an adjacent growing space via an opening in said barriers.

The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description of the Invention and no limitation as to the scope of the present invention is intended by either the inclusion or non-inclusion of elements, components, etc. in this Summary of the Invention. Additional aspects of the present invention will become more readily apparent from the Detail Description, particularly when taken together with the drawings.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a front elevation view of a hydroponic plant growing system of one embodiment of the present invention;

FIG. 2 is a detailed view of FIG. 1;

FIG. 3 is a front elevation view of another embodiment of the present invention;

FIG. 4 is a partial front elevation view of another embodiment of the present invention;

FIG. 5 is a detailed view of an upper portion of a hydroponic plant growing system showing one method of interconnecting a hydroponics bag to a support;

FIG. 6 is a detailed view of an upper portion of a hydroponic plant growing system showing another method of interconnecting a hydroponics bag to a support;

FIG. 7 is a detailed view of an upper portion of a hydroponic plant growing system showing another method of interconnecting a hydroponics bag to a support;

FIG. 8 is a partial detailed view of an upper portion of a hydroponic plant growing system showing another method of interconnecting a hydroponics bag to a support;

FIG. 9 is a detailed view of FIG. 8;

FIG. 10 is a detailed view of a hydroponic plant growing system of one embodiment of the present invention showing one method of connecting the hydroponics bag to a waste pipe;

FIG. 11 is a front elevation view of hydroponics bag of another embodiment of the present invention showing a longitudinal tube associated with one edge of the hydroponics bag;

FIG. 12 is a front elevation of yet another embodiment of the present invention that employs a clip seal to control the flow of nutrient fluid; and

FIG. 13 is a schematic view of one embodiment of the present invention that illustrates one method of use.

To assist in the understanding of one embodiment of the present invention the following list of components and associated numbering found in the drawings is provided:

| # | Components |
|---|---|
| 2 | Hydroponic plant growing system |
| 6 | Bag |
| 10 | Front surface |
| 14 | Rear surface |
| 18 | First lateral edge |
| 22 | Second lateral edge |
| 26 | Growing space |
| 30 | Barrier |
| 34 | Opening |
| 38 | Growing medium |
| 42 | Liquid source |
| 46 | Hook |
| 50 | Support |
| 54 | Channel |
| 58 | Spot welds |
| 62 | Arm |
| 64 | Loop |
| 65 | Net pot |
| 66 | Top end |
| 67 | Opening |
| 68 | Barrier |
| 69 | Root zone |
| 70 | Reinforced portion |
| 71 | Rod |
| 72 | Wire |
| 73 | Pipe |
| 74 | Lower most portion |
| 75 | Longitudinal opening |
| 78 | Connector |
| 82 | Waste pipe |
| 86 | Emitter tube |
| 90 | Fluid opening |
| 94 | Clip |
| 98 | Corrugation |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

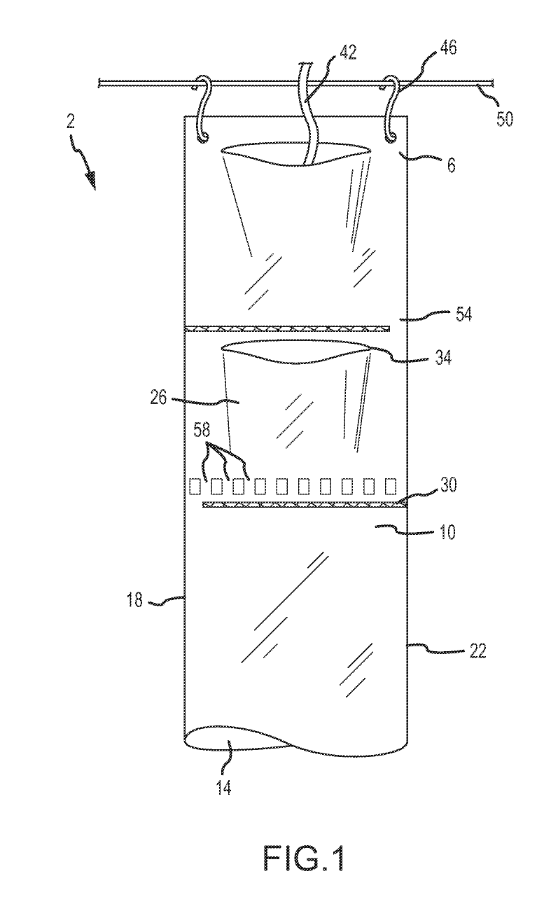

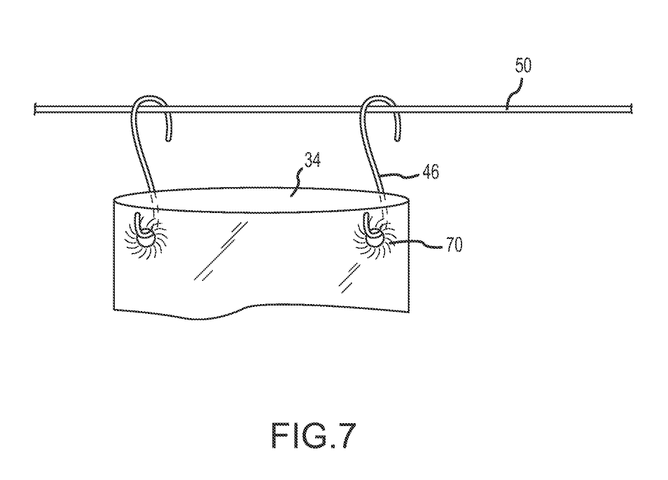

Referring now to FIGS. 1-13, a hydroponic plant growing system 2 is shown that is comprised of a hydroponics bag 6, which is generally flat plastic tubing having a front surface 10 and a rear surface 14 interconnected on a first lateral edge 18 and a second lateral edge 22. The hydroponics bag 6 includes a plurality of growing spaces 26 that are separated by a barrier 30. Growing media 38 and associated plants are introduced into the growing space 26 via at least one opening 34. The uppermost opening 34 of the hydroponics bag 6 is associated with a liquid source 42 that supplies fluid to the growing space 26 that percolates to the lowermost growing space of the bag 6. The bag 6 of embodiments of the present invention is interconnected via hooks 46 or other mechanisms to a horizontal support 50.

In one embodiment of the present invention, the growing space 26 selectively receives a bag or pouch of root barrier material which allows removal of an associated plant without disturbing adjacent plants that are not ready for harvest. The contemplated removable bag may be prefilled with a plant and growing medium and then placed in a growing space of the hanging hydroponic bag 6, which allows processing of individual plants.

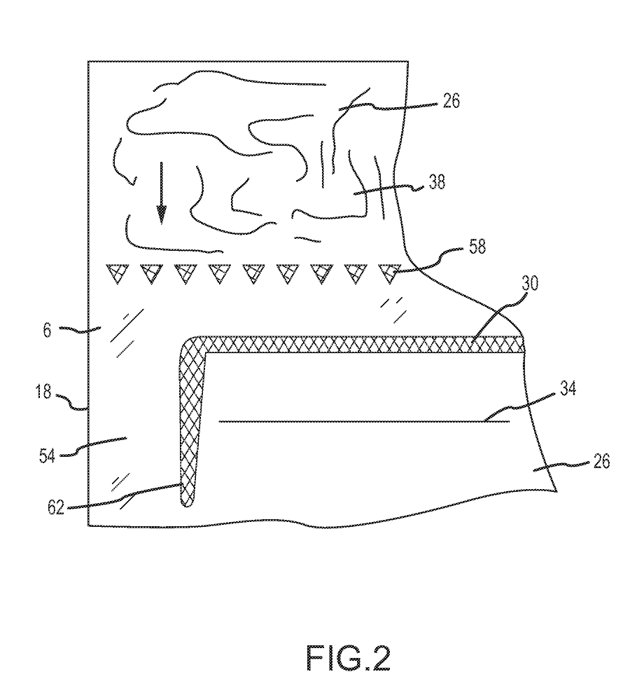

Referring now specifically to FIGS. 1 and 2, the hydroponic bag 6 is shown having a plurality of openings 34, which may be in the form of a slit, that provides access to a growing space 26. The growing space 26 is bounded by the barrier 30, which is formed by a continuous ultrasonic weld that begins at the first lateral edge 18 or second lateral edge 22 of the bag. The weld ceases prior to the opposite lateral edge of the bag 6 which defines a channel 54 that allows nutrient solution to flow from an upper growing space 26 to an adjacent, lower growing space. A plurality of spot welds 58 may also be included above at least one barrier 30 to help retain media or roots of the growing plant.

The spot welds 58, which may be made in any shape, are positioned between the first edge 18 and the second edge of the bag 6. Growing medium 38 and nutrient solution reside above the spot welds 58 and accommodate a plant. The spot welds 58 may be tapered to help prevent growing media particles from clogging the space between welds. In operation, the nutrient solution will collect beneath the spot welds 58 and drain via the channel 54 to the adjacent growing space 38. Further, an ultrasonic weld with a downward oriented arm 62 may be employed, which further defines the channel 54 and isolates the opening 34 of an adjacent growing space to help prevent solution egress. The opening 34 shown may be positioned on the front surface and/or the back surface of the bag 6. In one embodiment of the present invention, the channel 54 is shielded from light to inhibit the growth of algae that could obstruct fluid flow. The bags 6 of some embodiments of the present invention, however, are made of clear plastic for the growing and harvesting of algae for biofuels, for example.

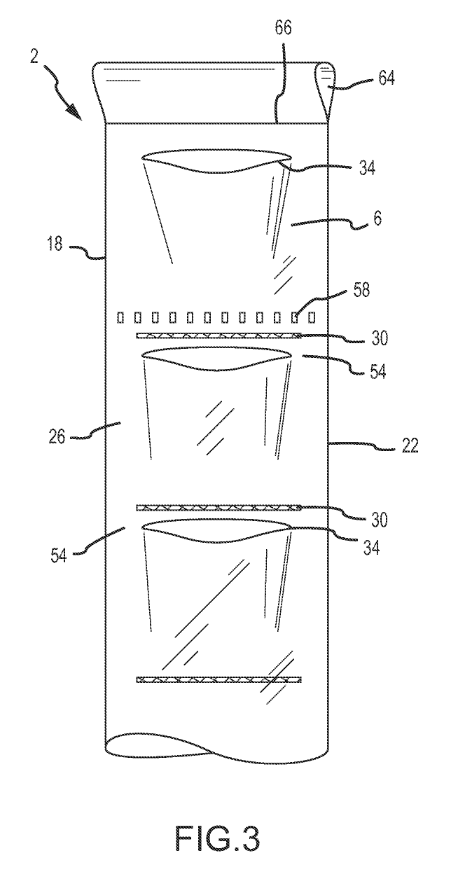

FIG. 3 shows another embodiment of the present invention that provides a loop at a top end 66 that receives a support member 50. Here, the barrier 30 spans between the first edge 18 and the second edge 22 but does not touch each edge to provide two channels 54. The channel 54 may receive t-tape, drip tape, etc. wherein fluid emitters are associated with each growing space 26.

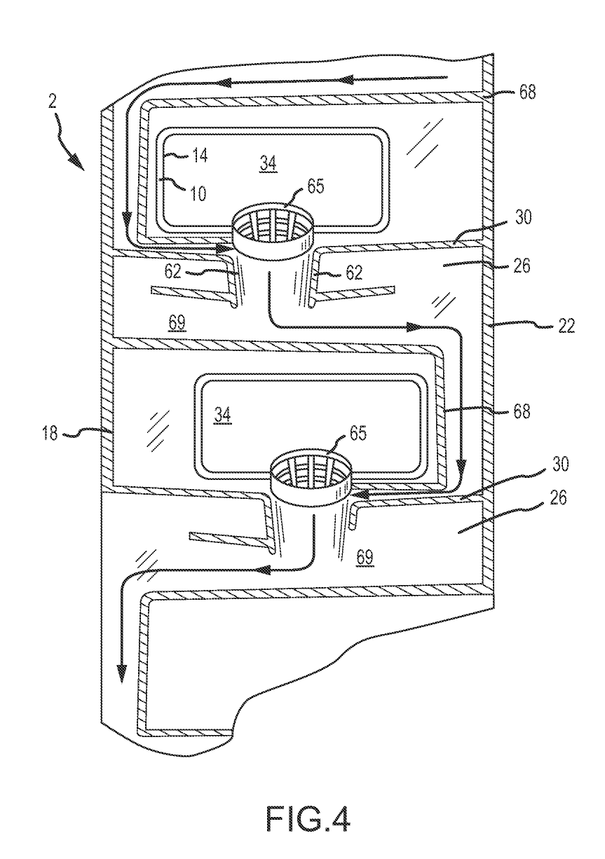

FIG. 4 shows yet another embodiment of the present invention that employs enlarged openings 34 that receive net pots 65 that are held in place by barriers 30. Here, the barriers 30 extend from the first edge 18 and the second edge 22 and include an opening 67 to which the net pot 65 is frictionally engaged. The barriers 30 may also have downwardly extending arms 62 that enhance support of the net pot 65. Further, the arms 62 may be angled slightly inwardly to increase the frictional engagement with the net pots. In order to accommodate the larger opening needed, embodiments of the present invention include a barrier 68, i.e. a weld about the openings. The distance between the net pot 65 and the barrier 68 associated with the opening 34 is defined as a root zone 69, the length thereof is dependent partially upon the plant being grown within the bag.

In operation, the plants and associated net pots 65 are inserted into openings 34 in the bag and frictionally engaged to the barriers 30 and associated arms 62. Fluid flow is to the root zone 69 via a channel 54. The fluid percolates around the net pot 65 and around adjacent openings 34 to the channel 54 associated with the next adjacent net pot 65. The barriers 68 about the openings prevent fluid from escaping the bag via the opening. As will be described in further detail below, fluid may be collected at the bottom most growing space 26 and returned by pump to the uppermost growing space.

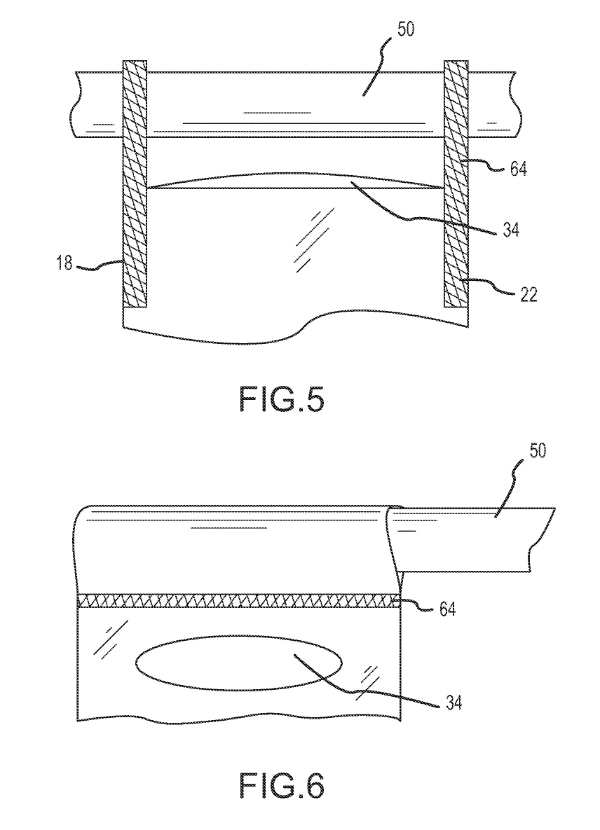

Referring now to FIGS. 5-7, various mechanisms for interconnecting the bag 6 to the support 54 is shown. FIG. 5 shows individual loops 64 that are associated with the first edge 18 and second edge 22 of the bag. Alternatively, the loop 64 may extend the width of the bag 6, for example, as shown in FIG. 6. Alternatively, hooks 46 may be used to interconnect the bag 6 to the horizontal support 50. In such case, the hooks 46 may interface with a reinforced portion 70 of the bag.

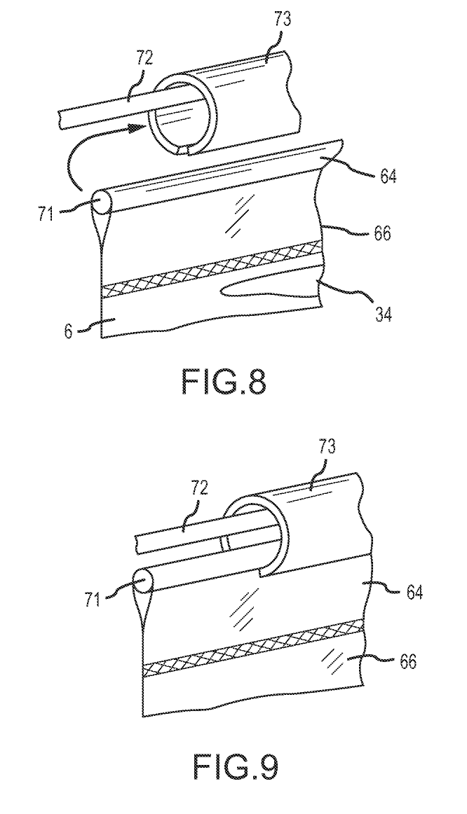

FIGS. 8 and 9 show another method of supporting a hydroponic bag. Here, the upper end 66 of the bag is associated with a rod 71 or thickened piece of plastic. The rod 71 may be integrated directly into the bag 6 or positioned within a loop 64 of plastic material that is welded or otherwise integrated to the bag 6. The bag is thus supported by a support wire 72 that accommodates a pipe 73 that receives the rod 71 and associated bag 6 within longitudinal opening 75.

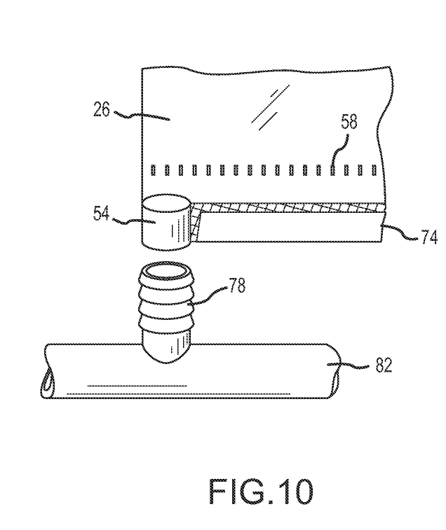

Referring now to FIG. 10, the lowermost portion 74 of a typical bag 6 is shown where the channel 54 is interconnected to a connector 78 that feeds into a waste pipe 82 that recirculates the nutrient solution. The spot welds 58 provide a separation of media from drainage area. The spot welds 58 may be formed of ultrasonic or heat welding just as any of the welds described above.

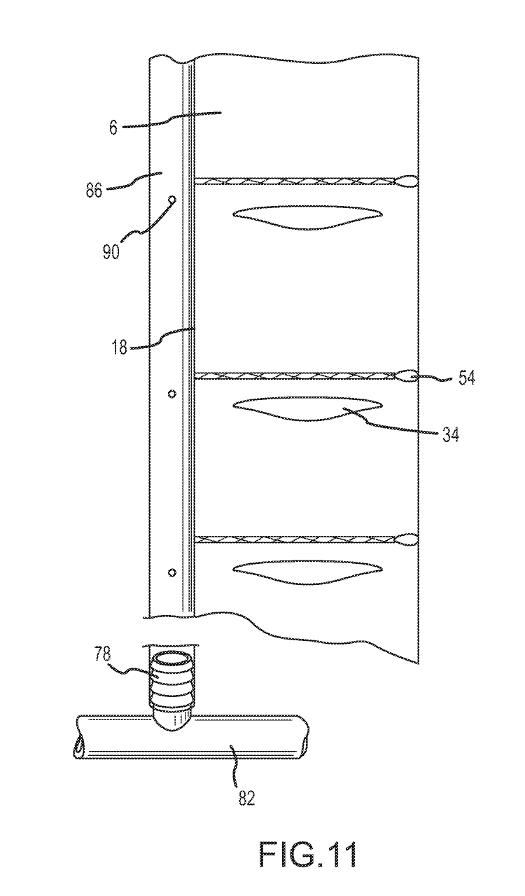

Referring now to FIG. 11, an embodiment of the present invention that employs a fluid emitter tube 86 integrated to the first edge 18 is shown. Here, the fluid emitter tube 86 has a plurality of fluid openings 90 wherein at least one fluid opening communicates with each growing space 26 of the hydroponic bag 6. The emitter tube 86 terminates at a connector 78 that is in communication with the waste pipe 82 as described above.

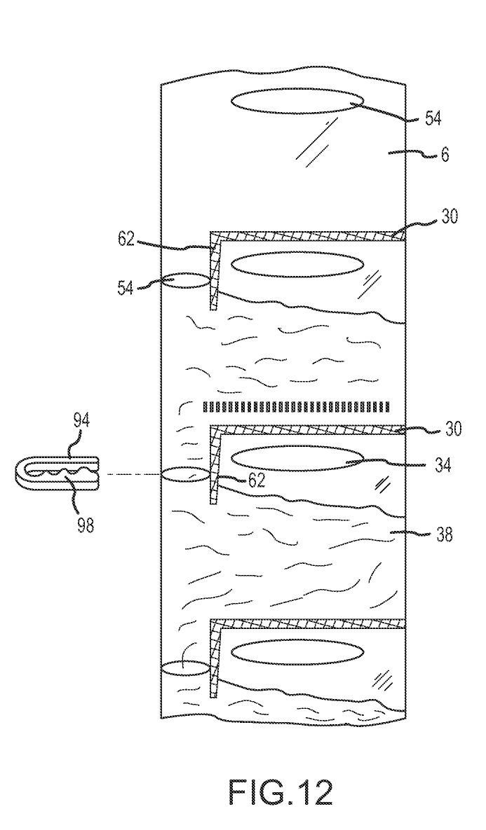

Referring now to FIG. 12, filling of a typical bag 6 is shown. A series of clips 94, which may include corrugations 98 that are used to change control fluid flow, and are used to selectively block the channels 54. The clips 94 interact with the arm 62 of the barrier of some embodiments of the present invention to achieve its desired purpose. The bag 6 of this and other embodiments of the present invention may also be vibrated to encourage flow of dry media.

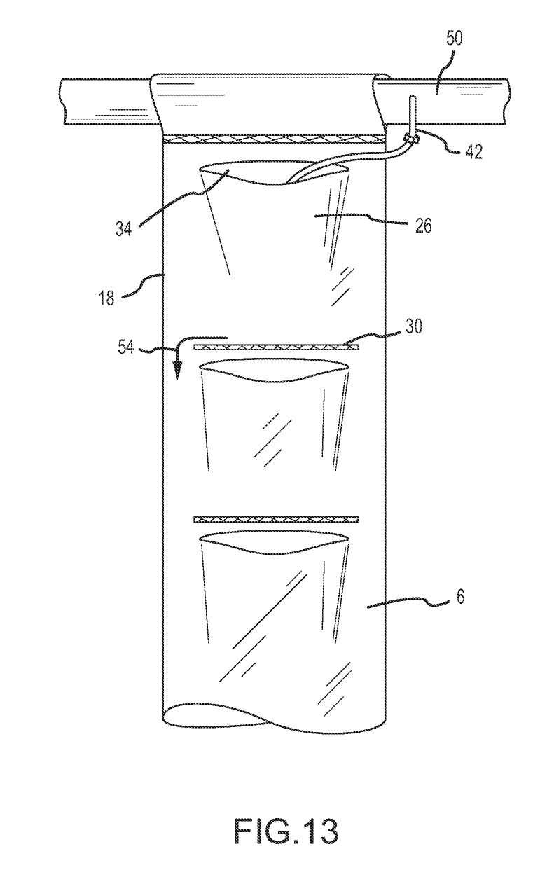

Referring now to FIG. 13, a method of operation is shown. The horizontal support member 50 may be a pipe that is connected to a reservoir of nutrient solution. A drip emitter 10 or sprayer, i.e., a liquid source 42, is interconnected between the pipe and the uppermost opening 34 of the hydroponics bag 6 to introduce fluid into the growing medium provided in the growing space 26. The media tends to bulge and distend the tube somewhat when fluid is introduced thereto. The size of the channel will control the rate of flow and saturation period. Further, fluid from the top bag will slowly drain into the next growing area by forming a gas exchange that repeats for the next bag and so forth. The size of the bags vary by their intended use.

While various embodiments of the present invention have been described in detail, it is apparent that modifications and alterations of those embodiments will occur to those skilled in the art. However, it is to be expressly understood that such modifications and alterations are within the scope and spirit of the present invention, as set forth in the following claims. Further, the invention(s) described herein is capable of other embodiments and of being practiced or of being carried out in various ways. In addition, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

What is claimed is:

1. A hydroponic bag, comprising:
a first surface and a second surface interconnected at a first edge and a second edge to define a flat tube;
a plurality of growing spaces located between said first surface and said second surface, each of said growing spaces associated with an opening formed in at least one of said first surface; and
a plurality of barriers provided between said first surface and said second surface that separate adjacent growing spaces, at least one of said plurality of barriers spanning only a portion of the distance between said first edge and said second edge such that at least one channel is provided that allows fluid communication between adjacent growing spaces.

2. The hydroponic bag of claim 1, wherein said plurality of growing spaces are aligned in series with one growing space positioned above its next adjacent growing space, and said bag further including an upper edge that is associated with a support.

3. The hydroponic bag of claim 2, wherein said support is adapted to carry fluid wherein said support is in fluidic communication with at least one growing space.

4. The hydroponics bag of claim 1, wherein said barrier is formed of weld between said first surface and said second surface.

5. The hydroponics bag of claim 1, further comprising a plurality of discrete barriers positioned above and adjacent to at least one of said plurality thereof.

6. The hydroponics bag of claim 1 wherein at least one barrier of the plurality thereof has a first edge associated with said second edge and a second edge positioned a predetermined distance from said first edge.

7. The hydroponics bag of claim 6, further comprising an arm that extends downwardly from said second end of said barrier, said arm extending into an adjacent growing area such that said opening associated with said adjacent growing area is positioned between said second edge and said arm.

8. The hydroponics bag of claim 1, further comprising a fluid emitter tube interconnected to at least one of said first edge and said second edge, said emitter tube having at least one opening that is in fluidic communication with at least one growing space.

9. A hydroponics growing system comprised of a tube with a plurality of openings that is hung vertically, said tube receiving growing media positioned in discrete growing spaces that receives a plant via said openings, said tube having at least one fluid inlet that is in fluid communication with said growing spaces, an improvement comprising:
non-continuous barriers located between adjacent growing spaces.

10. The system of claim 9, wherein said barrier is formed by interconnecting opposite surfaces of said tube.

11. The system of claim 9, wherein said tube is comprised of a first surface and a second surface that are interconnected on lateral edges thereof, and said barrier extending from one lateral edge and terminating a predetermined distance from an opposite lateral edge such that a fluid channel is formed between adjacent growing spaces.

12. The system of claim 9, wherein said openings are positioned adjacent from said barrier.

13. The system of claim 9, wherein fluid that is added to the bag is collected by a waste pipe that is interconnected to a lower edge of said bag.

14. A method of growing plants comprising:
providing a hydroponic bag that is comprising a series of fluidically associated discrete growing areas, each growing area being accessible by an opening in said bag;
proving non-continuous barriers between said growing spaces;
adding growing medium to said discrete growing spaces;
introducing a plant into said growing space;
introducing a fluid to said hydroponic bag; and
percolating said fluid from one growing space to an adjacent growing space via an opening in said barriers.

15. The method of claim 14, further comprising providing a plurality of spot welds above said barrier that supports said plant.

16. The method of claim 14, further comprising collecting said fluid and recycling the same.

17. The method of claim 14, further comprising selectively altering the fluid path located between adjacent growing spaces.

18. The method of claim 14, further comprising altering the shape of said growing spaces by altering the pressure of the fluid.
